(19) United States
(12) Patent Application Publication
(10) Pub. No.: US 2024/0257247 A1
(43) Pub. Date: Aug. 1, 2024

(54) SYSTEMS AND METHODS FOR COMMISSION ALLOCATION

(71) Applicant: BGC PARTNERS, INC., NEW YORK, NY (US)

(72) Inventors: Howard W. Lutnick, New York, NY (US); Michael Sweeting, Aldershot (GB); Joseph C. Noviello, New York, NY (US)

(21) Appl. No.: 18/633,727

(22) Filed: Apr. 12, 2024

Related U.S. Application Data
(63) Continuation of application No. 18/072,814, filed on Dec. 1, 2022.
Application No. 18/072,814 is a continuation of application No. 11/213,601, filed on Aug. 26, 2005, now abandoned.
(60) Provisional application No. 60/605,091, filed on Aug. 27, 2004.

(51) Int. Cl. G06Q 40/04; G06Q 30/0207; G06Q 30/0601

(52) U.S. Cl. CPC G06Q 40/04; G06Q 30/0239; G06Q 30/0601

(57) ABSTRACT

The invention relates to systems and methods that allocate different types of commissions to participants based on at least one factor contributing to the liquidity to the market in which an item trades. The commission may accordingly depend on the order in which trading commands are received from different participants and/or the sides the participants are on. The systems and methods receive trade commands from different participants on the item, match these trade commands, determine a commission or reward based on the added liquidity and allocate the commission or reward to certain participants.

### CROSS-REFERENCE TO RELATED APPLICATIONS

This application is a continuation of U.S. patent application Ser. No. 18/072,814 filed Dec. 1, 2022, which is a continuation of U.S. patent application Ser. No. 11/213,601 filed Aug. 26, 2005, which claims the benefit of U.S. Provisional Application No. 60/605,091 filed Aug. 27, 2004, each of which is incorporated by reference herein in its entirety.

### FIELD OF THE INVENTION

This invention relates to the allocation, collection and distribution of commissions received from the trading of financial instruments in electronic trading systems. More particularly, the present invention relates to determining and displaying of commissions charged for trading various tradable items including financial instruments, such as interest-rate-related instruments, equity instruments, derivatives thereof, etc.

### BACKGROUND OF THE INVENTION

Electronic matching and dealing systems have found successful application in many trading activities, including the buying and selling of a variety of items including goods, services, and currency and securities. Indeed, almost all trading today involves some computer support, from simple information delivery to sophisticated trading systems that automate transactions at select criteria.

Nevertheless, electronic matching systems have not significantly impacted the issues of formalizing, determining, and allocating the commissions or fees charged to various buyers and sellers who participate in different aspects of the trading processes through their transactions. Moreover, the trading logic used by such systems or platforms (which operates similarly to a voice broker in non-electronic trading) typically does not allow for the full disclosure of such commissions and fees to users until after trades have been processed or confirmed.

It would be therefore desirable to provide systems and methods for the electronic trading of such items that implement sophisticated commission allocations in transaction management of items being traded and that fully and clearly disclose, in real-time, the brokerage fees charged to the participants prior to final settlement.

### SUMMARY OF THE INVENTION

Therefore, it is an object of the invention to provide systems and methods for the electronic trading of such items that implement sophisticated commission allocations in transaction management of items being traded and that fully and clearly disclose, in real-time, the brokerage fees charged to the participants prior to final settlement.

The above and other objects are accomplished in accordance with the principles of the invention by providing systems and methods that implement commission allocations in transaction management of items such as financial instruments being traded by participants. Participants may include brokers, traders, professionals, customers and users of such systems and methods. The systems and methods may receive a first trade command from a first participant to buy or sell an item at a desired price and a second trade command from a second participant to transact the item. The systems and methods may then match the first and second trade commands thereby executing a trade on the item, determine a commission or reward relating to the trade, and allocate the commission or reward to at least one of the first and second participants.

The systems and methods may allocate different types of commissions or provide commission incentives to different participants based on at least one factor contributing to the liquidity to the market pertaining to the traded items. The level of liquidity added, hence the commission, may depend on the order in which a trading command is received from the participant (e.g., whether there were existing orders at the specified price on the item being traded and the number of such orders) and/or the side of a trade the participant is on. Alternatively or additionally, the level of liquidity added, hence the commission, may depend on the stage during which the participant starts or joins a trade, the degree or extent of participation in the trade, the nature of the item being traded, etc. Such commissions or commission incentives may be varying amounts of brokerage fees, reductions, or elimination of the same, rewards such as credit, rebates, and combinations of the same. By providing commission incentives, such as reduced commissions, to participants who take particular actions such as showing markets and the monetary value of securities, currency and/or goods for sale, and/or initiating or joining in a transaction for securities, currency and/or goods, these systems and methods reward market participants for contributing to market liquidity, market transparency and/or price discovery.

The systems and methods also fully and clearly disclose, in real-time, the commissions charged to participants, or the rewards given to them, simultaneously with or prior to, the execution or confirmation of a trade. For example, in some embodiments of the present invention, the commission or reward may be made explicit through being added to or subtracted from the trade price displayed in real-time to the participants either prior to or immediately after a trade is executed, instead of being added to or subtracted from the final trade price subject to a post-trade settlement process.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a block diagram of an exemplary system that may be used to implement the processes and functions of certain embodiments of the present invention;

FIG. 2 shows a flow diagram for commission allocation according to certain embodiments of the present invention; and

FIGS. 3A-3E, 4A-4B, 5A-5B and 6A-6F are illustrations of portions of an interactive display that may be displayed to users in accordance with certain embodiments of the present invention.

### DETAILED DESCRIPTION OF THE INVENTION

The invention is directed to systems and methods that implement commission allocations in transaction management of items such as financial instruments being traded by participants. Participants may include brokers, traders, professionals, customers and users of such systems and methods.

The systems and methods may allocate different types of commissions or provide commission incentives to different participants based on at least one factor contributing to the liquidity to the market pertaining to the traded items. The level of liquidity added, hence the commission, may depend on the order in which a trading command is received from a participant (e.g., whether there were existing orders at the specified price on the item being traded and the number of such orders) and/or the side of a trade the participant is on. Alternatively or additionally, the level of liquidity added, hence the commission, may depend on the stage during which the participant starts or joins a trade, the degree or extent of participation in the trade, the nature of the item being traded, etc. Such commissions or commission incentives may be varying amounts of brokerage fees, reductions, or elimination of the same, rewards such as credit, rebates, and combinations of the same. By providing commission incentives, such as reduced commissions, to participants who take particular actions such as showing markets and the monetary value of securities, currency and/or goods for sale, and/or initiating or joining in a transaction for securities, currency and/or goods, these systems and methods reward market participants for contributing to market liquidity, market transparency and/or price discovery—i.e., the general process of determining prices through the impact of the actions of participants on marketplace supply and demand conditions.

The systems and methods also fully and clearly disclose, in real-time, the commissions charged to participants, or the rewards given to them, simultaneously with or prior to the execution or confirmation of a trade. For example, in some embodiments of the present invention, the commission or reward may be made explicit through being added to or subtracted from the trade price displayed in real-time to the participants, instead of being added to or subtracted from the final trade price subject to a post-trade settlement process. Disclosing the commission or reward prior to the execution of a trade paints a better picture of the full costs involved, thereby giving participants an improved opportunity to consider whether or not to participate in the trade.

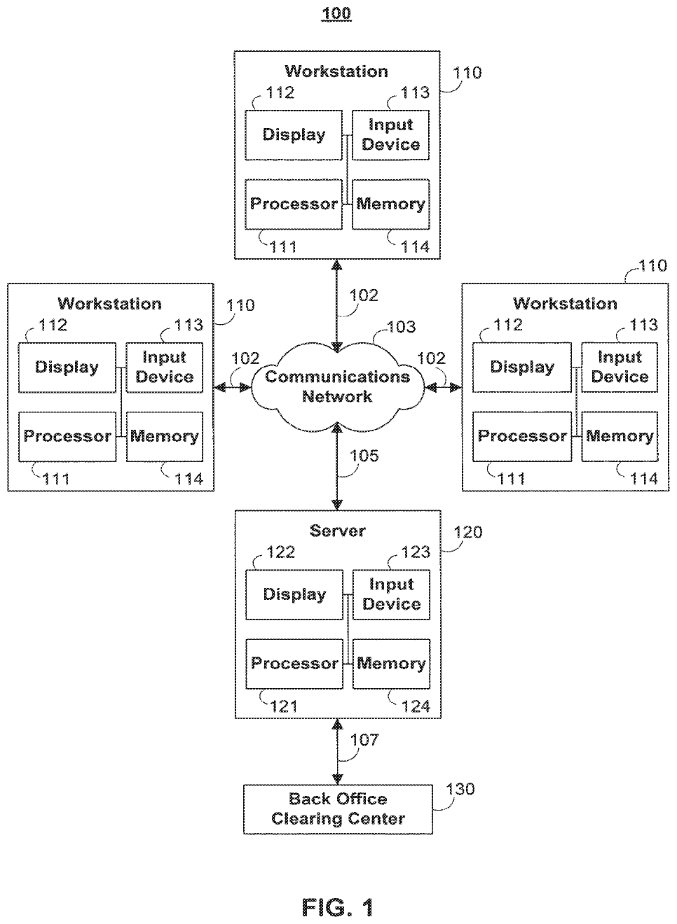

Further details of the invention are described below in relation to FIGS. 1-6.

Referring to FIG. 1, exemplary system 100 for implementing the invention is shown. As illustrated, system 100 may include one or more workstations 110. Workstations 110 may be local or remote and are connected by one or more communications links 102 to communications network 103 that is linked via communications link 105 to server 120. Server 120 may be linked to back office clearing center 130 via communications link 107.

Server 120 may be any suitable server, processor, computer, data processing device, or combination of the same. Server 120 may be used to implement the governing logic that processes and executes orders and trades, and distributes trade and market information, including price and size information, to workstations 110. Communications network 103 preferably includes the Internet but may consist of any suitable computer network such as an intranet, a wide-area network (WAN), a local-area network (LAN), a wireless network, a digital subscriber line (DSL) network, a frame relay network, an asynchronous transfer mode (ATM) network, a virtual private network (VPN), or any combination of the same. Communications links 102 and 105 may be any communications links suitable for communicating data between workstations 110 and server 120, such as network links, dial-up links, wireless links, hard-wired links, etc.

Workstations 110 may be personal computers, laptop computers, mainframe computers, dumb terminals, data displays, Internet browsers, Personal Digital Assistants (PDAs), two-way pagers, wireless terminals, portable telephones, etc., or any combination of the same. Workstations 110 may be used by participants to enter trade commands such as bid, offer, buy and sell orders for the items being traded and view market activity corresponding to these items. Workstations 110 may also convey the commissions charged or rewards awarded to their users.

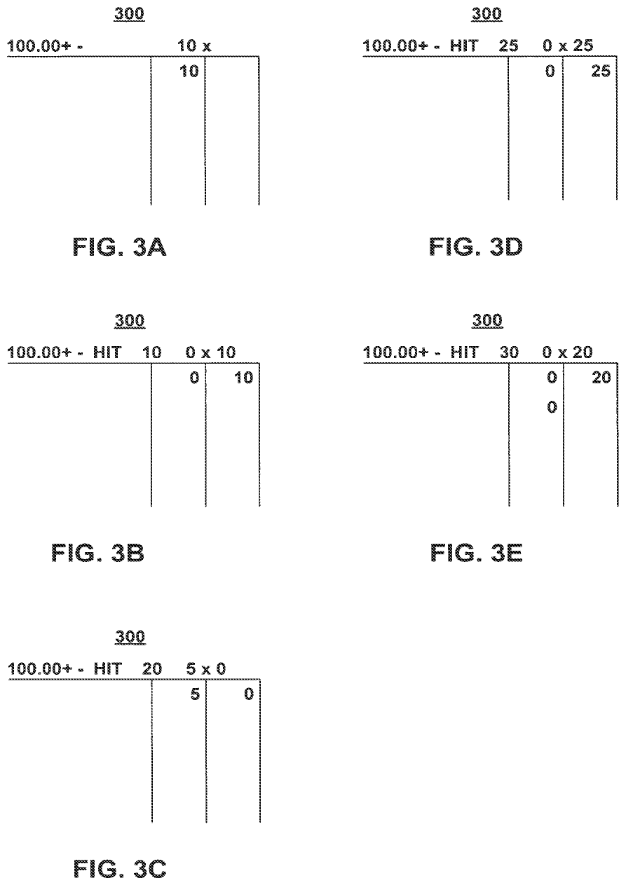

A typical workstation 110 may include processor 111, display 112, input device 113, and memory 114, which may be interconnected. In a preferred embodiment, memory 114 includes a storage device for storing a workstation program for controlling processor 111. The workstation program may include a trading application for running the trading interfaces shown in FIGS. 3-6 and displayed on display 112. Input device 113 may be used in conjunction with display 112 by users to enter trade commands such as bids/offers on desired items and to execute and monitor trades. Processor 111 may use the workstation program to receive trade and commission/reward information relating to the items being traded by multiple users of system 100, or other users, and display such information on display 112 or communicate such information to display 112.

Server 120 may include processor 121, display 122, input device 123, and memory 124, which may be interconnected. In a preferred embodiment, memory 124 includes a storage device for storing a server program that provides the governing logic for controlling processor 121. The governing logic may be used to process trade commands received from workstations 100 and may dictate the trading options and screen displays on each workstation. Processor 121 may use the server program to process trade commands communicated from various workstations that are operated by multiple users of system 100, or other users, execute trades determine commissions and rewards and communicate information related thereto to workstations 110 and/or back office clearing center 130. More specifically, processor 121 may use the server program to receive trade commands to on specific items, match such commands, determine corresponding commissions or rewards and allocate them to the different participants as appropriate.

Back office clearing center 130 may be any suitable equipment, such as a computer, a laptop computer, a mainframe computer, etc., or any combination of the same, for causing trades to be settled and/or verifying that trades are settled. Communications link 107 may be any communications links suitable for communicating data between server 120 and back office clearing center 130, such as network links, dial-up links, wireless links, hard-wired links, etc.

Through the workstations, the server and the governing logic, the systems and methods may trade securities at accelerated levels with minimal errors and costs, control commission elements during real-time trading, allocate commissions or fees to market participants, provide incentives for market-makers or participants initiating or joining particular sides of a trade or potential trade or during a stage of trading or a particular trading state and distribute commission and transaction data in real-time.

According to some embodiments of the present invention, the governing logic may provide for a particular sequence of trading states during which each potential trader participates in the transactions that are entered. As each state is provided, different rules to trading may apply. Exemplary states that may be implemented are described in U.S. patent application Ser. No. 09/553,423, filed Apr. 19, 2000, which is hereby incorporated by reference herein in its entirety.

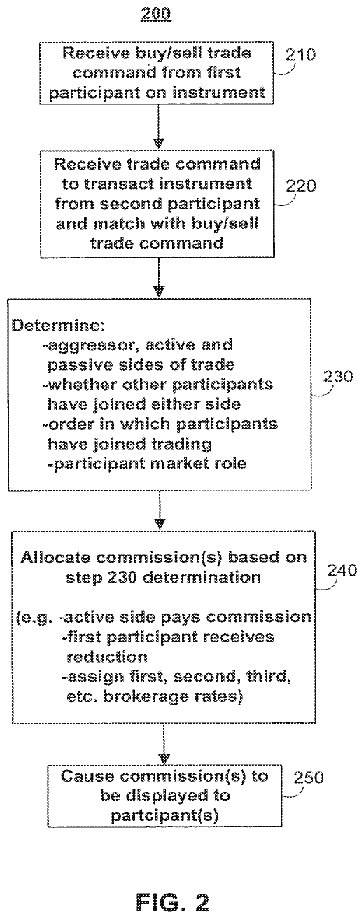

For example, in one such state, participants input bids and offers on various items through the workstations as shown in FIG. 2. FIG. 2 illustrates a process 200 that may be implemented by server 120 of FIG. 1. At step 210, a participant may enter a trade command to buy and/or sell a particular item that is received by the trading application implemented on system 100 of FIG. 1. Such a trade command may be a bid and/or an offer. Each bid and offer may specify the price for which such participants are willing to buy or sell a select item. In addition or instead, each bid and offer may specify the size of the proposed trade—i.e., the monetary volume of the pending bid/offer. Alternatively, the trade command need not specify a particular price or size. For example, a participant may indicate a desire to trade at the market price if certain conditions are met.

The participant who entered such a trade command may be a market-maker. A market-maker may be a participant maintaining a two-sided market on a particular item—i.e., showing a simultaneous bid and offer for the same item at the same time-during market hours, thereby indicating a willingness either to buy or to sell issues of the item in accordance with his or her market role as a facilitator of price discovery, transparency, and liquidity. A participant's market role relates to and is defined based on the stage during which he or she starts or joins a potential trade and/or the degree or extent of his or her participation in the trade. A market-maker may be a participant who enters a bid and/or offer on an item, thereby adding liquidity to that item. The market-maker may add such liquidity at the request of the trading system, end users, customers, the general marketplace or for any other appropriate reason. The market-maker may or may not be the first participant to enter a bid and/or offer on the item.

Once the trade command (e g/the bid and/or offer position) is displayed on the workstations, another participant or participants may transact a desired size of the item by, for example, accepting the bid or offer at step 220. A first seller or buyer may accept the bid or offer by entering a trading command that is received by the trading application to hit or lift at least a portion of the entire size that is made available in the bid or offer. The governing logic may either automatically or interactively match the different trading commands entered by the participants based on the prices and/or sizes that are specified by the participants. For example, the governing logic may determine whether at least one participant has acted to accept the pending bid or offer and may transact a particular size of the item between them.

At step 230, if a participant acted to accept a bid or an offer, he or she may be promoted to a new level known as an aggressor denoting the active side of the trade. If a participant accepts a pending bid, the aggressor is said to have submitted a hit. In such a case, selling becomes the active side of the trade and buying is passive. If a participant accepts a pending offer, the aggressor is said to have submitted a lift. In such a case, buying becomes the active side of the trade and selling is passive. The governing logic may keep track of both active and passive sides of the transaction in order to properly allocate the appropriate commissions the participant at step 240. Moreover, the governing logic may keep track of other participants joining the trade, the order in which such participants join the trade and/or participant market role at step 230 in order to properly allocate the appropriate commissions to the different participants at step 240. The governing logic may predict what side a potential participant could join a trade as well as his or her market role before the participant acts by, for example, hitting or lifting an existing bid or offer or joining a trade.

For example, the active side may pay the commissions on the ensuing transaction. This allocation of commissions is premised on the notion that the active participants are taking advantage of the price information and liquidity, while the passive participants are supplying price information and liquidity to the market. Entered bids or offers may entitle participants who posted them to commission reductions. Such reductions may also be available to participants maintaining two-sided markets showing current bids and offers on the same items. Such a provision rewards participants, including market-makers, for providing liquidity to the market.

At step 250, the governing logic may cause the commission allocated in step 240 to be displayed to the appropriate participant. The commission may be included in the price displayed to the participant or may be displayed separately. Moreover, the commission may be displayed after a trade is executed. Alternatively, the commission associated with a trade may be displayed prior to the execution of such trade such that the price dynamically changes as trading progresses, as discussed further below. Disclosing the commission prior to the execution of the trade paints a better picture of the full costs involved, thereby giving participants an improved opportunity to consider whether or not to participate in the trade.

Preferably, a participant placing a passive bid or offer will be assigned a first brokerage rate. This rate may be applied to any trade in which the total size posted by the passive participant is hit or lifted. This rate may or may not be applied to new bids or offers locking an already existing price. The price displayed to the participant may reflect this rate. The first brokerage rate may be also referred to as the passive screen display rate, which is discussed in connection with FIGS. 3-6.

According to some embodiments of the present invention, transactions forming a trade may take place during subsequent states. One such state may occur pursuant to a hit or lift by an aggressor hitting or lifting part of or the entire size that is made available by the passive participant. A time period during which exclusive rights to the trade may be given to the aggressor to trade additional size of the item with the passive participant who placed the bid or offer that was hit or lifted by the aggressor may be provided. Such a time period may be pre-determined, may be determined during the period leading up to the trade or may be determined at the time of the trade. At least during such a state, the passive participant who placed the bid or offer that was hit or lifted may be referred to as the contra-trader, while the aggressor may be referred to as the first buyer/seller. The aggressor may be assigned a second brokerage rate that may be greater than the first brokerage rate. Again, this is because the aggressor is taking advantage of the price information and liquidity supplied by the passive participant. This rate may or may not be applied to the full amount hit or lifted by the aggressor. The price displayed to the aggressor may reflect this rate. The price may be updated to reflect such a rate before the aggressor hits or lifts the bid or offer during the trading state. The second brokerage rate may be also referred to as the screen activator rate, which is discussed in connection with FIGS. 3-6.

The first buyer/seller, contra-trader or any third party who bids or offers further size after the initial trade may be assigned a third brokerage rate, in return for the added liquidity. The third brokerage rate may be smaller than the second brokerage rate but greater than the first brokerage rate due to the additional unmatched size contributed to the market. This rate may or may not be applied to any bids or offers previously placed before the initial hit or lift by the aggressor. The third brokerage rate may be also referred to as the passive joiner rate.

Any participant joining the first buyer/seller, contra-trader or third party on the active side for the further size offered after the initial hit or lift may be assigned a fourth brokerage rate. The fourth brokerage rate may be greater than the third brokerage rate for taking advantage of the added liquidity. This rate may or may not be applied to any hit or lift size previously posted to initiate the trade. The fourth brokerage rate may be also referred to as the active joiner rate.

The price displayed to a participant who bids or offers further size or who joins the first buyer/seller may be updated to reflect the passive or active joiner rate depending on what side the participant is on. The governing logic may predict what side on which the participant may trade and update the price accordingly before the participant takes action.

The above logic may be better understood in the context of the examples discussed in connection with FIGS. 3-6. Each one of these figures shows a portion of an interactive display that may be shown on display 112 of FIG. 1 and that may be associated with the electronic trading of any items including financial instruments, such as equity instruments, interest-rate-related instruments, and derivates thereof. Each one these portions may be referred to as a trading quadrant (“quad”). Common to each quad is a horizontal line above which the cumulative sizes bid, offered, and traded (hit or lifted) are displayed, along with the corresponding best price(s) (highest bid and/or lowest offer). Bid sizes are displayed to the left of offer sizes. The individual sizes contributed by each participant are displayed below the horizontal line and are aligned with the corresponding cumulative sizes. Whenever a bid is successfully hit, an indicator displaying the word HIT may appear adjacent to the price. Similarly, whenever an offer is successfully lifted, an indicator displaying the word TAK may appear adjacent to the price. With every successful trade, the total size traded may be updated. The area to the left below the horizontal may be used to display the cumulative sizes bid, offered, and traded at the next best price(s).

For example, FIGS. 3A-3E show quad 300 which displays the following actions: 1) a first trader enters a 100.00+ bid for 10 million (“10 m”) issues of a particular item as shown in FIG. 3A, 2) a second trader desires to sell 20 m issues into the 100.00+ bid thereby hitting 10 m and offering 10 m as shown in FIG. 3B, 3) the first trader desires to buy another 15 m issues thereby trading 10 m on the original hit for a total of 2 am traded and bidding 5 m as shown in FIG. 3C, 4) the second trader desires to sell another 30 m issues thereby hitting 5 m for a total of 25 m traded and offering 25 m as shown in FIG. 3D, and 5) a third trader joins to buy 5 m issues and trades after the first trader has completed trading for a total of 30 m traded and 20 m left untraded as shown in FIG. 3E. It should be noted that a zero may be displayed in appropriate size locations in the quad to indicate to participants monitoring trading activity that, although some size was available for trading, there is no longer any more size bid or offered.

According to some embodiments of the present invention, the first trader may be charged a passive screen display rate on the initial 10 m issues and a passive joiner rate on her next 15 m issues. The second trader may be charged a screen activator rate on his initial 20 m hit and an active joiner rate on the next 10 m issues (5 m to the first trader and 5 m to the third trader after the first trader is done). The third trader may be charged an active joiner rate on his 5 m issues.

Accordingly, market-makers who have contributed to improving liquidity in less desirable, lucrative, or liquid items may be assigned lo er first brokerage rates as compared to rates associated with other items. Subsequent trades involving such items may also be assigned lower second, third and fourth brokerage rates.

One of ordinary skill in the art should appreciate that the present invention may be practiced in embodiments other than those illustrated herein. For example, the commission allocation structure described herein may be applied to any kind of trading system or exchange such as auction trading systems, interactive matching systems, automated matching systems, price improvement systems, FIFO (First In, First Out) systems, RFQ (Request for Quote) systems, etc., and may be applied to the trading of any types of items. In any such systems, different commission rates may apply to different participants, depending on what side of a trade they are on, their point of entry to the trade, the degree or extent of their participation in the trade and/or whether there were prior existing bids and offers on the item being traded. Specifically, according to a preferred embodiment of the present invention, market-makers may be charged passive screen display rates, while other customers may be charged screen activator rates and participants subsequently joining a particular trade may be charged passive or active joiner rates, depending on the side of the market and/or stage of the trade these participants choose to join. This includes cases where participants are or are not granted exclusive rights to trade, cases where participants are or are not provided with a share of a trade based on their status such as professional traders, market-makers and generic customers, their market role such as the stage during which they start or join a trade and/or their degree or extent of participation, cases where participants are or are not provided with shares of a trade on a pro-rata basis based on existing agreements or distribution algorithms, or any combination of the same.

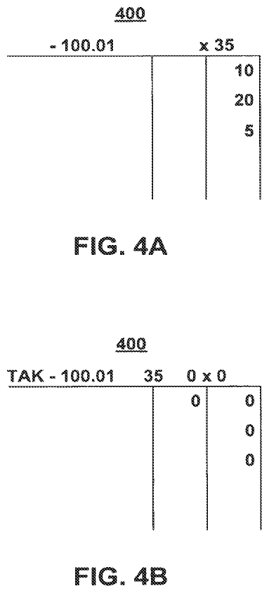

For example, the following example discussed in connection with FIGS. 4A and 4B relates to automatic matching of previously entered orders and quotations with incoming orders and quotations. FIGS. 4A and 4B show quad 400 in which the following are entered: 1) a first participant offer of 10 contracts at price 100.01, 2) a second participant offer for 20 contracts at the same price, and 3) a third participant offer for 5 contracts at the same price as well thereby totaling 35 contracts, as shown in FIG. 4A.

Assuming an order to buy 35 contracts at that price is subsequently entered by a fourth party as shown in FIG. 4B, the system may allocate the 35 contracts such that the first participant receives 10 contracts, the second participant receives 20 contracts, and the third participant receives 5 contracts. According to some embodiments of the present invention, the first participant may be charged a passive screen display rate, while the second and third participants may be charged a passive joiner rate. The fourth party may be charged a screen activator rate for the trade. Alternatively, the second participant may be charged a reduced passive joiner rate for joining the trading process following the first participant but prior to the third participant.

Accordingly, different brokerage rates may be assigned to participants depending on the order in which their trading commands are successfully received in an automatic matching system and other systems. Trading commands received in different orders may affect liquidity differently. For example, the first few trading commands received on a particular day leading to initial market activity for the item may add more liquidity than the 30th trading command entered as a reaction to the obvious increase in activity for the item later that day.

In other embodiments pf the present invention, if the system in the previous example is an exchange that allocates shares based on participant status, where the first participant is a professional trader, the second participant is a market-maker and the third participant is a generic customer, the system may match 5 contracts with the generic customer order to sell 5 contracts first. The system may then allocate the remaining 30 contracts such that the market-maker receives 20 and the professional trader receives 10. If the fourth party order was for 30 contracts instead of 35, the system may allocate the remaining 25 contracts on a pro-rata basis between the market-maker and the professional trader, after matching 5 contracts with the generic customer. In such a situation, a pro-rata agreement may be in effect between the participants. A pro-rata agreement is an agreement that relates to the allocation of size exchanged between participants whereby size traded at a price is distributed amongst buyers or sellers not on a first-come first-served basis, but as a pro-rata share according to how much size is available for matching. For example, if an 80%/20% agreement exists in favor of the market-maker, the market-maker may receive 20 contracts, while the professional trader may receive 5. Alternatively, the system may allocate the remaining 25 contracts between the market-maker and the professional trader according to an existing distribution algorithm. In any event, according to some embodiments of the present invention, the market-maker may be charged a passive screen display rate. Both the generic customer and the professional trader may be charged a passive joiner rate, while the fourth party may be charged a screen activator rate for the trade.

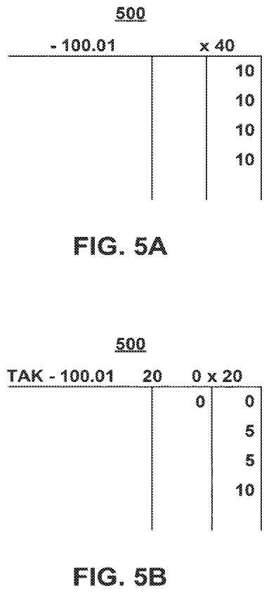

The following discussion in connection with FIGS. 5A and 5B is an example of another embodiment of the present invention relating to automatic matching. FIGS. 5A and 5B show quad 500 of an interactive display in which: 1) a first participant shows an offer of 10 contracts at price 100.01, 2) a second participant subsequently shows an offer for 10 contracts at the same price, 3) a third participant subsequently shows an offer for 10 contracts at the same price, and 4) a fourth participant subsequently shows an offer for 10 contracts at the same price as well thereby totaling 40 contracts, as shown in FIG. 5A.

In this case, an order to buy 20 contracts at that price is subsequently entered by a fifth party as shown in FIG. 5B. The system may allocate the 20 contracts between the parties such that the first participant sells more than 5 contracts, and the second, third and fourth participants sell 5 or fewer contracts, for a total transaction size of 20 contracts, the allocation being made subject to an algorithm pursuant to a pro-rata agreement in effect between the parties. For example, the first participant may sell all 10 of his contracts, while the second and third sell 5 each and the fourth does not sell any. The first participant may be charged a passive screen display rate, while the second and third participants may be charged a passive joiner rate. The fifth party may be charged a screen activator rate for the trade. Alternatively, the second participant may be charged a reduced passive joiner rate for joining the trading process following the first participant but prior to the third and fourth participants.

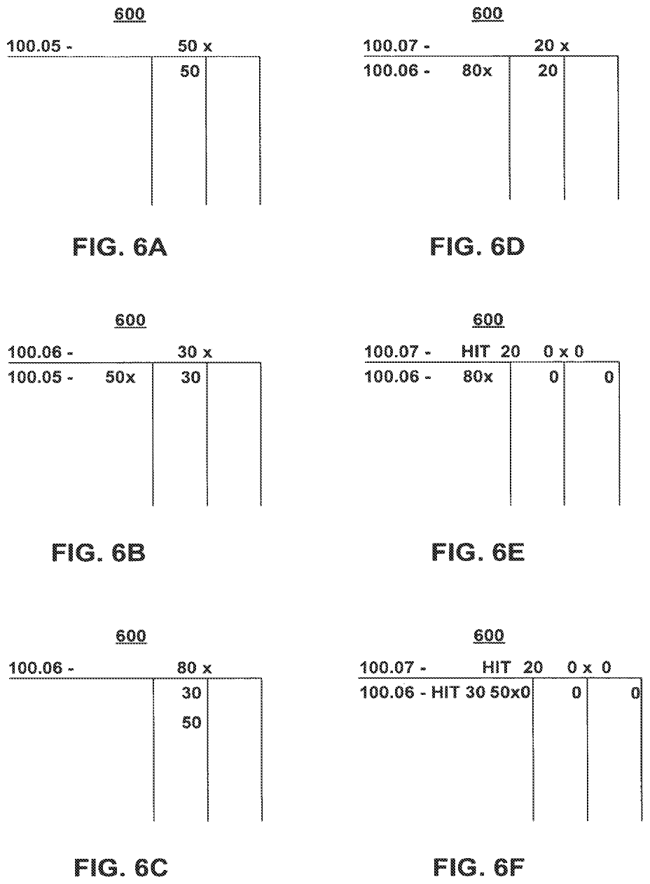

The following discussion in connection with FIGS. 6A-6F is an example of yet another embodiment of the present invention in a marketplace which starts off an auction among participants to compete for the size being sold. FIGS. 6A-6F show quad 600 of an interactive display in which a sell order for a particular size is received from a first party for a particular item. This sell order may have an initial price at which the first party is willing to sell or may not be priced. Further suppose that: 1) a market-maker enters a 100.05 bid for a 50 m size of the item in FIG. 6A, 2) a broker improves upon the bid by entering a bid for 100.06 for a 30 m size of the item in FIG. 6B, 3) the market-maker joins the broker at 100.06 in FIG. 6C and cancels her previous bid, and 4) a second broker enters a 100.07 bid for a 20 m size of the item in FIG. 6D. Assuming an order to sell a 50 m size at the best price by the first party, the system may match 20 m size with the second broker's order at 100.07, which is the best available price, in FIG. 6E. The system may then allocate the remaining 30 m size between the market-maker and the first broker at 100.06, which is the next best available price, in FIG. 6F.

The market-maker may be granted most of the size for making the market or according to a distribution algorithm or existing agreement between the various participants. According to some embodiments of the present invention, each one of the market-maker and the two brokers may be charged a passive joiner rate for showing a new price on their side of the market. Alternatively, the market-maker only may be charged a passive screen display rate, while both brokers may be charged passive joiner rates for entering after the market-maker has shown the market. Meanwhile, the first party may be charged a screen activator rate if his sell order was entered after the market-maker's bid. Had the first party entered his order prior to the market-maker's entering the bid with an associated sell price, the first party may be charged a passive screen display rate, on account of being the first party to show a price, thus setting the starting level for the auction.

Whenever applicable, the commissions charged to the participants, or the rewards given to them, may be added to, or subtracted from, the trade price displayed to the participants with or prior to the execution or confirmation of the trade in FIGS. 3-6. As such, the trading price may be dynamically updated as trading progresses in a given trading state.

It should be understood that the foregoing is only illustrative of the principles of the present invention, and that various modifications can be made by those skilled in the art without departing from the scope and spirit of the invention.

The trading application described herein may be any suitable, software, hardware, or both configured to implement the features of the invention, The trading application may be located at a central location (e.g., a central server such as server 120 of FIG. 1) and instances thereof may be stored on workstations connected thereto (e.g., workstations 101 of FIG. 1). In another suitable approach, the trading application may reside among different locations (e.g., a network such as communications network 103 of FIG. 1).

The trading systems and methods described above, or variation thereof, may be implemented in conjunction with the interactive displays discussed or shown herein, or in conjunction with variations on those displays.

One of ordinary skill in the art should appreciate that the invention may be practiced in embodiments other than those described herein. For example, it will be understood that the size, shape, arrangement, and labels of various portions of the interactive displays discussed or shown are examples shown for purposes of illustration only. It will be understood that modifications of any or all of the foregoing characteristics of these portions are within the scope of the invention.

It will be understood that the foregoing is only-illustrative of the principles of the invention, and that various modifications can be made by those skilled in the art without departing from the scope and spirit of the invention, and the invention is limited only by the claims that follow.

1. A method implemented on an electronic trading system, the method comprising:
receiving a first trade command from a first participant to buy or sell an item at a desired price;
receiving a second trade command from a second participant to transact the item;
matching the first and second trade commands thereby executing a trade on the item;
determining a commission or reward based on an order in which the first and second trade commands are received; and
allocating the commission or reward to at least one of the first and second participants.
